(19) United States
(12) Patent Application Publication
(10) Pub. No.: US 2026/0062040 A1
(43) Pub. Date: Mar. 5, 2026

(54) SYSTEMS AND METHODS FOR ACTION-ASSISTED TRAFFIC MANAGEMENT

(71) Applicant: Siemens Mobility, Inc., New York, NY (US)

(72) Inventors: Heinrich Helmut Degen, Plainsboro, NJ (US); Monica McKenna, North Berwick, ME (US); Remo Ferrari, East Brunswick, NJ (US); Brian D. Lawry, Murrysville, PA (US); John Tyler, Calgary (CA)

(73) Assignee: Siemens Mobility, Inc., New York, NY (US)

(21) Appl. No.: 18/818,748

(22) Filed: Aug. 29, 2024

(51) Int. Cl. B61L 27/04; B61L 25/02; B61L 27/70; G08G 1/01; G08G 1/09

(52) U.S. Cl. CPC B61L 27/04; B61L 25/02; B61L 27/70; G08G 1/0125; G08G 1/09

(57) ABSTRACT

A method for managing traffic includes, through operation of a processor, receiving traffic network data including sensor data from a plurality of sensors, wherein the traffic network data include vehicle data and infrastructure data within a traffic network, identifying a deviation in a planned traffic network behavior based on the traffic network data and utilizing a defined parameter, wherein the deviation includes a value outside a threshold of the defined parameter, determining a confidence level for the defined parameter and value, wherein the confidence level is calculated by evaluating whether one or more condition(s) associated with the defined parameter and value are true, identifying a causal factor for the deviation, generating actions for the causal factors to correct the deviation, wherein an output includes a list of automated actions and manual actions, and triggering the automated actions.

### TECHNICAL FIELD

Aspects of the present disclosure generally relate to traffic management, such as controlling, guiding and ensuring safety of traffic. More specifically, aspects relate to systems and methods for action-assisted traffic management. Traffic management and related systems and methods as used herein can be applied to systems and networks for vehicles, such as to trains, buses, airplanes, taxis etc. Further, traffic management as described herein may also be applied to network traffic or data traffic. For example, data packages and associated traffic may be managed with the described systems and methods.

### BACKGROUND ART

Traffic control and management systems are used to govern operation of traffic and associated traffic control equipment, such as traffic signals with signal plans. In an example of railway applications including trains, dispatchers plan and control train routes using a dispatch system. The dispatch system provides a means to monitor and track trains, control switches and signals to clear routes for trains, as well as issuing authorities for areas of track that are not controlled by signals. Objectives of a dispatcher include maximizing safe train throughput based on a given schedule, keeping on-track workers safe and handling exceptions safely and in a timely manner.

There are many factors that can impact a safe and scheduled delivery. Today, such impacts are manually investigated, and appropriate responses are determined manually. When operations change or unexpected situations occur, the dispatcher's job is to change the authorities/routes in a safe manner to implement a new plan. This leads often to missed options, delayed responses, and partially ineffective responses. Thus, there may be a need for an improved traffic management system.

### SUMMARY

Methods and systems for managing traffic are described herein. A first aspect of the present disclosure provides a method for managing traffic, the method comprising, through operation of at least one processor in a traffic management system configured via computer executable instructions included in at least one memory, receiving traffic network data including sensor data from a plurality of sensors, wherein the traffic network data comprise vehicle data and infrastructure data within a traffic network, identifying a deviation in a planned traffic network behavior based on the traffic network data and utilizing a defined parameter, wherein the deviation comprises a value outside a threshold of the defined parameter, determining a confidence level for the defined parameter and value, wherein the confidence level is calculated by evaluating whether one or more condition(s) associated with the defined parameter and value are true, identifying a causal factor for the deviation, generating actions for the causal factors to correct the deviation, wherein an output includes a list of automated actions and manual actions, and triggering the automated actions.

A second aspect of the present disclosure provides a traffic management system comprising at least one memory and at least one processor, and a traffic management module configured, via the at least one processor and the at least one memory, to receive traffic network data including sensor data from a plurality of sensors, wherein the traffic network data comprise vehicle data and infrastructure data within a traffic network, identify a deviation in a planned traffic network behavior based on the traffic network data and utilizing a defined parameter, wherein the deviation comprises a value outside a threshold of the defined parameter, determine a confidence level for the defined parameter and value, wherein the confidence level is calculated by evaluating whether one or more condition(s) associated with the defined parameter and value are true, identify a causal factor for the deviation, generate actions for the causal factors to correct the deviation, wherein an output includes a list of automated actions and manual actions, and trigger the automated actions.

A third aspect of the present disclosure provides a non-transitory computer readable medium storing executable instructions, which, when executed by a computer, perform a method for traffic management as described herein.

### BRIEF DESCRIPTION OF THE DRAWINGS

FIG. 1A and FIG. 1B illustrate a flow chart for a method for managing traffic in accordance with an exemplary embodiment of the present disclosure.

FIG. 2 illustrates a simplified flow chart and diagram for managing traffic including a machine learning algorithm in accordance with an exemplary embodiment of the present disclosure.

FIG. 3 illustrates a block diagram of a traffic management system in accordance with an exemplary embodiment of the present disclosure.

FIG. 4 illustrates a diagram of a train management and control system in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of systems and methods for traffic management, for example in connection with train control and dispatch systems.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

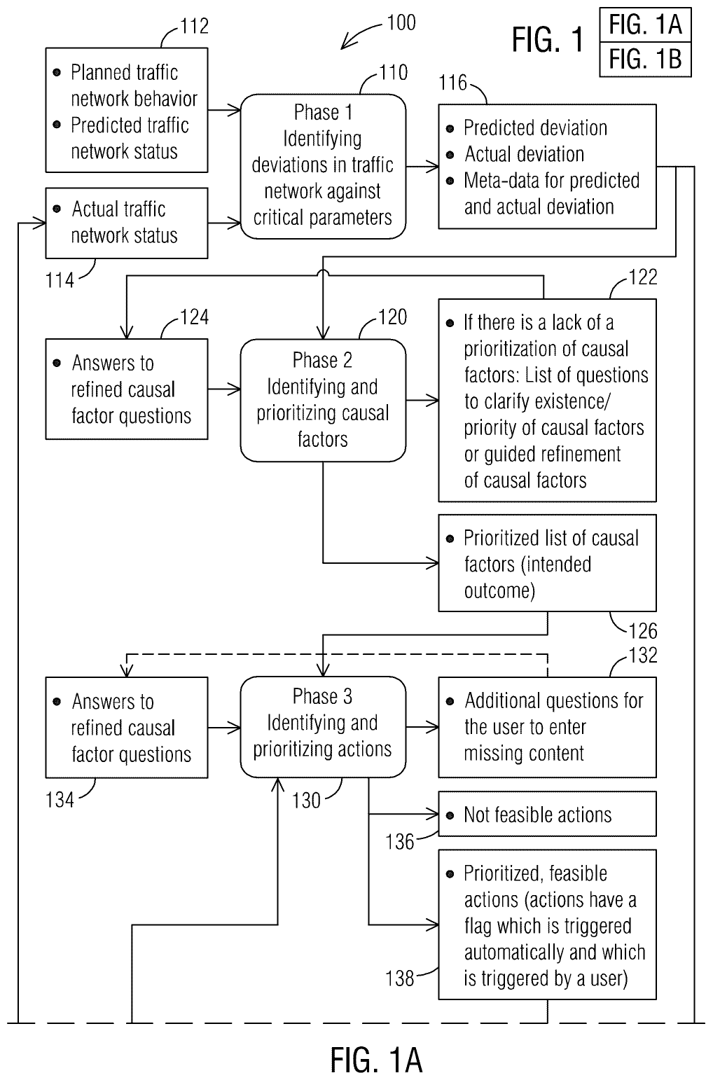

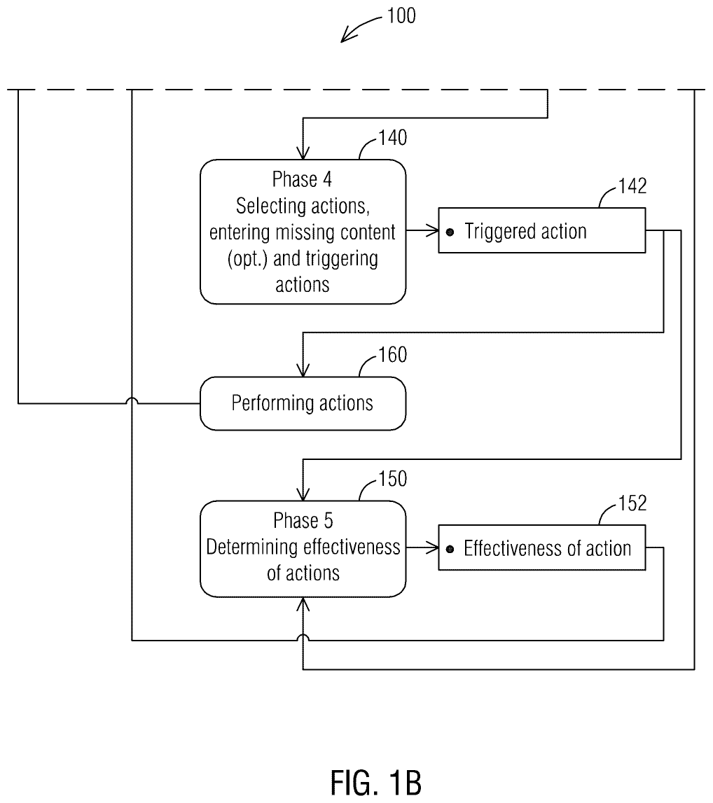

FIG. 1A and FIG. 1B illustrate a flow chart for a method 100 for managing traffic in accordance with an exemplary embodiment of the present disclosure.

As noted above, traffic control and management systems are used to govern operation of traffic and associated traffic control equipment. Traffic must be coordinated for a safe and scheduled delivery. There are many factors that can impact a scheduled delivery. When operations change or unexpected situations occur, authorities and/or routes need to be changed in a safe manner to implement a new plan.

In accordance with an exemplary embodiment of the present disclosure, the method 100 for managing traffic includes features of becoming aware of unplanned events that impact scheduled delivery in traffic systems, identifying root causes and proposing actions/responses to the unplanned events, and evaluating how effective such actions/responses are.

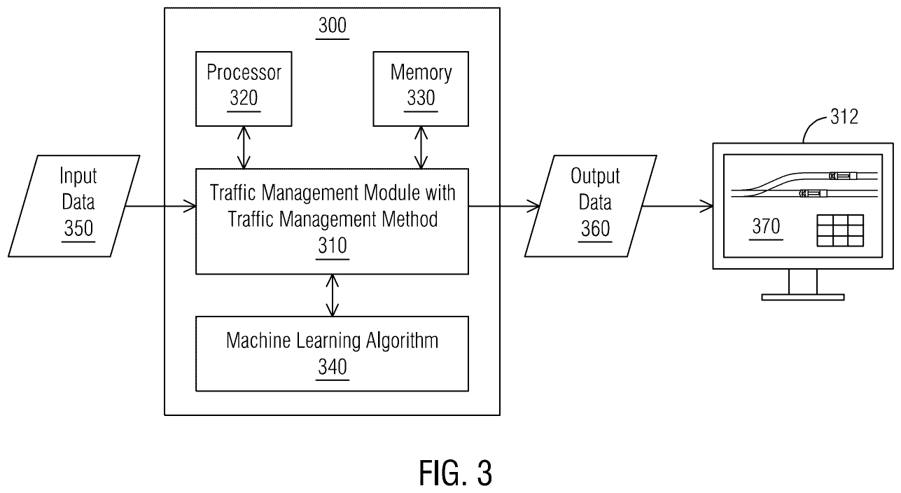

While the method 100 is described as a series of acts that are performed in a sequence, it is to be understood that the method 100 may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein. The method is performed by a traffic management system as described herein, for example a traffic management system 300 described with reference to FIG. 3.

The computer implemented method 100 comprises multiple phases and acts or steps within each phase. The following is described in connection with a train traffic management method and system. However, it should be noted that the methods and systems are not limited to train traffic management but can also be applied to bus traffic management, airplane traffic management, taxi traffic management etc.

### Phase 1

In accordance with an embodiment of the present disclosure, act 110 includes phase 1. Phase 1 comprises receiving traffic network data including sensor data from a plurality of sensors, wherein the traffic network data comprise vehicle data and infrastructure data within a traffic network and identifying a deviation in a planned traffic network behavior based on the traffic network data and utilizing a defined parameter, wherein the deviation comprises a value outside a threshold of the defined parameter.

More specifically, input 112 to phase 1 comprise a planned traffic network behavior, e. g. a traffic schedule or plan, and a predicted traffic network status based on the planned behavior. A further input 114 is an actual traffic network status. The actual traffic network status is obtained via traffic network data from vehicles and infrastructure within a traffic network. Infrastructure data can be sensor data from a plurality of sensors. For example, a traffic signal sensor may transmit signal sensor data including for example an error message indicating that the signal is faulty. Vehicle data can be data from vehicle on-board units. For example, a train on-board unit may transmit information about the respective train. Further, vehicle data can be data from vehicles at different locations, situations or conditions, such as data from vehicles in yards, shops, maintenance etc. and data collected from on the route vehicles.

The deviation in the planned traffic network behavior is identified based on the received traffic network data and utilizing defined parameters, which are critical parameters. Critical parameters can be for example arrival time of a train, departure time of a train, and hours of service (HOS) of a crew. With reference to train operations, a train crew may not work past a certain number of hours on duty, which is typically 12 hours.

For each critical parameter, thresholds are defined (see table below). Alarm thresholds (A) and warning thresholds (W) are examples of threshold types per parameter. Each threshold type has a value range, defined by a lower value (L) and an upper value (U). A value range can have a lower value or an upper value only. A threshold may be a single minimum or maximum value only and may not be a value range.

| Critical Parameter | Threshold Type | Threshold Range |
|---|---|---|
| Parameter 1 | Alarm | Value 1 (A, L)-Value 1 (A, U) |
| Parameter 1 | Warning | Value 1 (W, L)-Value 1 (W, U) |
| Parameter 2 | Alarm | Value 2 (A, L)-Value 2 (W, U) |
| Parameter 2 | Warning | Value 2 (W, L)-Value 2 (W, U) |
| Parameter N | . . . | . . . |

Based on the defined parameters and their associated thresholds, deviations within the traffic network can be determined. A deviation occurs, when a value of the received traffic data is outside a threshold or threshold range of the respective parameter. For example, the parameter is time of departure of a train and input data indicate that the train is late. Outputs 116 of phase 1 include predicted deviation, actual deviation and meta-data for the predicted and actual deviations.

### Phase 2

In accordance with an embodiment of the present disclosure, act 120 includes phase 2. Phase 2 comprises identifying a causal factor for the deviation, and prioritizing, when more than one causal factor has been identified, the causal factors by applying a ranking function and utilizing a confidence level. The confidence level is determined for each defined parameter and value, wherein the confidence level is calculated by evaluating whether one or more condition(s) associated with the defined parameter and value are true.

In an embodiment, inputs into phase 2 are the outputs 116 of act 110, which are predicted deviation, actual deviation and meta-data for the predicted and actual deviations. The confidence level CL per parameter and value is calculated as follows:

$$C {L}_{i , j} = \frac{{\sum }_{i , j , k = 1}^{n} {Condition}_{i , j , k} = true}{n}$$

The conditions are associated via configuration and programming with the defined parameters and values (see table below). If a condition is true, it counts as one (1). If a condition is not true, it counts as zero (0). N is the number of conditions for a combination of parameter (i) and value range (j). Some conditions are marked as mandatory. If they are not true, the confidence level is set to zero (0).

The causal factors are then ranked by applying a ranking function, sorted by the confidence level CL (highest confidence level first), wherein p is the variable for the parameter identifier and v is the variable for the range value identifier:

$$Rank ( C L ) = Vector ( C {F}_{p , v} , C {F}_{p , v} , … , C {F}_{p , v} )$$

| Parameter | Deviations | Traffic Network | Causal | Confidence |
|---|---|---|---|---|
| i | j | Conditions | factor | Level |
| Parameter | Value | Condition 1.1.1 | Causal | CL 1, 1 |
| 1 | range 1 | | factor 1.1 | |
| Parameter | Value | Condition 1.1.2 | Causal | CL 1, 2 |
| 1 | range 2 | | factor 1.2 | |
| Parameter | Value | Condition 2.1.1 | Causal | CL 2, 1 |
| 2 | range 1 | | factor 2.1 | |
| Parameter | Value | Condition 2.1.2 | Causal | CL 2, 2 |
| 2 | range 2 | | factor 2.2 | |
| Parameter | . . . | | | |
| N | | | | |

In case there is insufficient information about conditions, a user is prompted (act 122) to enter information/contend for the respective condition. The answers and content provided by the user is then additional input 124 into phase 2 (act 120). Outputs 126 of phase 2 comprise a prioritized list of causal factors.

### Phase 3

In accordance with an embodiment of the present disclosure, act 130 includes phase 3. Phase 3 comprises generating or identifying actions for the causal factors to correct or handle the deviation(s), wherein an output includes a list of automated actions and manual actions and prioritizing the automated actions and manual actions in accordance with the causal factors.

In an embodiment, inputs for phase 3 includes the output 126 of act 120, that is the prioritized list of causal factors. The causal factors are associated via configuration and programming with actions. In phase 3, actions are provided and ranked in accordance with the ranked/prioritized causal factors. That means, an action for a causal factor with a high priority will also receive a high priority. If there is insufficient content, the user is queried for additional information in act 132. Answers to the questions of act 132 are then input 134 into act 130.

Further, it is determined which actions are feasible, given the environment and circumstances of the traffic network. Thus, outputs are not feasible actions 136 and feasible actions 138. A list of prioritized feasible actions 138 is created, wherein each action indicates whether it can be triggered automatically, for example by a management system, or whether the action requires user interaction to trigger the action. “Feasible actions” as used herein include actions that are available to be performed or can be performed within a certain time frame and/or within a certain budget. For example, an action may suggest replacing an engine in a locomotive because the locomotive broke down—this may not be a feasible action because there is no engine available for replacement. Even if an engine is available, it still may not be feasible because it takes too much time. Instead, the rail cars (wagons) may be coupled to a nearby locomotive that is available (feasible option).

Examples of actions generated in phase 3 include:
Weather alert, such as flooding, for a track area: a dispatcher message for that location is generated automatically.
Train's authority will run out in x minutes: a new authority is provided in sufficient time so that the train doesn't stop, considering the train's planned route.
A new dispatcher message being processed overlaps an existing authorized path for a train: allowing the dispatcher message processing to continue (impact is not significant), verbally contact the crew with instructions how to avoid enforcement, delay the processing of the dispatcher message.

### Phase 4

In an embodiment of the present disclosure, act 140 includes phase 4. Phase 4 comprises displaying the list of automated actions and manual actions, receiving a user input including a selection of one or more automated and/or manual actions, and triggering the actions. Further, if necessary, the user may enter missing content for a specific action.

Input to phase 4 is the list of prioritized and feasible actions 138, created in phase 3. Each action indicates whether the action can be triggered automatically or is presented to the user for manual triggering of the action. Output of phase 4 are triggered actions 142, which are then performed (act 160).

In an embodiment, there is a separate process for the automated actions and the user triggered actions, herein referred to as manual actions. Automated actions include actions that are triggered without user input or user interaction. These actions are triggered automatically to be performed and completed. These actions may be performed by a system or module that performs the method 100 for traffic management, or may be performed by a different, separate system. In such a case, a command is forwarded to the system that performs the action. Automated actions can be triggered, forwarded and/or performed in priority order, or in parallel, if possible, or in another order. For example, in case of an extreme weather event, a dispatcher message is created and transmitted (broadcast) automatically for the affected area.

Manual (manually triggered) actions include actions that require a user input. In an embodiment, a list of actions with their recommended priority is generated and displayed, and the user can choose which actions to perform, or the user can dismiss recommended actions. The user selects the actions that should be triggered and provides a respective input. In some cases, the action requires additional information from the user. For example, in the case of an authority expiring in x minutes, the system can recommend issuing a new authority. When the user selects to perform this action, the system will trigger the process to create the authority, which can be to gather the new authority limits/location, any additional information to communicate to the train crew.

Multiple actions can be selected, where there is no dependency on the actions. For example, if crew hours are expiring, there are multiple, independent actions to address the causal issue. The dispatcher may select an action to initiate a taxi to pick up the existing crew at a certain location. They may also select an action to call the next crew to take over the train, along with any transportation coordination to the pickup location. They may also select an action to prepare the train sheet for the next leg of the train's trip.

In other cases, the selection of one action will remove other proposed action options, wherein then the user/dispatcher must choose between action options which they want to perform. For example, in the case when a new dispatcher message being processed overlaps with an existing authorized path for a train, the dispatcher has three options to choose from, e.g., allow the dispatcher message processing to continue, verbally contact the crew with instructions how to avoid enforcement, or to delay the processing of the dispatcher message. Selection of one of these options removes the other options as actions to be performed. Once the dispatcher (user) has selected the action(s) to perform and entered any additional information needed to perform the action, these actions and supporting information are submitted to be processed. In an embodiment, the method 100 and associated system are designed so that all possible actions and their dependencies as well as possible action sequences are maintained (e.g., action 1 must be triggered before action 2, etc.).

### Phase 5

In an embodiment of the present disclosure, action 150 includes phase 5. Phase 5 comprises collecting and storing data of defined parameters in conjunction with performed actions, and analyzing an impact of the defined parameters, thereby determining an effectiveness of the performed actions.

A purpose of phase 5 is to establish a relationship between the action taken and the actual change that occurred within the traffic system. By establishing this relationship, it can be determined if an action resulted in a positive or negative impact on the critical parameters, i.e. the effectiveness of the action. Over time, accumulation of the effectiveness of the actions can be used to prioritize the actions offered in phase 3 (act 130).

Input in phase 5 includes the triggered actions 142, and predicted deviations, actual deviations, meta-data for predicted and actual deviations, that is the output 116 of phase 1. Further inputs are timestamp(s) when actions were taken, and for each action, a list of critical parameters related to the action.

Multiple approaches may be utilized to determine the effectiveness of an action 152. These approaches may be generic or tailored to the specific action/critical parameter relationship. In one embodiment, a record is kept of the critical parameters related to the action at the point in time the action is taken and for a period after the action was taken. Once a statistically significant sample of data has been collected, it could be analyzed to determine if the critical parameters were impacted positively or negatively, and by how much, as opposed to other causal factors.

In an example, a locomotive issue is reported on a train which is causing an expected delay in arrival time. In this example, a critical parameter is the arrival time of the train. If three (3) different actions are possible, over time, as the three options have been presented and used, it is possible to see and evaluate which action best improved the resulting arrival time of the train.

In another embodiment, a list of questions is presented to the user to ‘score’ the effectiveness of the action taken. Over time, as information is collected from multiple examples and multiple users, these scores could be used to measure the effectiveness of an action versus other possible actions. Output 152 includes effectiveness of the actions taken in relation to the critical parameters.

### Example

In the following, an example for the method 100 is described. A train crew for Train 1 was ordered at 07:00 and arrived at Yard A at 10:00, with a planned time of departure at 11:00. Train 1 should arrive at 14:25, leaving 4 hours and 35 minutes remaining on a train crews 12-hour clock (crew time expires at 19:00).

### Deviation 1

Situation: Train 1 has arrived in Yard A and stops to fuel its locomotives. When Train 1 is ready for departure, the train crew finds that the mid-train locomotive is not operating. Unable to get the failed locomotive running, the train crew notifies the yard manager.
Symptom: Equipment indication: The mid-train locomotive failed while Train 1 is in Yard A; train cannot depart.
Parameter: Estimated departure time is unknown; arrival time might be delayed.
Root cause: Certain part of the locomotive is broken.
Action(s): Fix or replace locomotive to get the Train 1 moving as soon as possible. The provided actions can be alternative actions (choose one of them), sequential actions, or a combination of both. In this example, the listed actions are alternatives, which means that one of the actions Action 1.1, Action 1.2, Action 1.3 and Action 1.4 can be selected.

### Proposed Actions (Alternatives):

Action 1.1: Inspect and provide a quick fix and leave Yard A; parameter: departure time.
Action 1.2: Replace locomotive with on-hand spare locomotive; parameter: departure time.
Action 1.3: Dead in tow; parameters: departure time; arrival time.
Action 1.4: Delay Train 1 to wait for a new locomotive; parameters: departure time; arrival time.

### Details to Actions:

Action 1.1: Mechanical department can perform a diagnostic check to determine the root cause. If a quick fix cannot be found, then other options need to be explored. This option has shortest time to the parameter, if a root cause can be found.
Action 1.2: Train crew will have to split Train 1 into multiple tracks, swap locomotives, and put Train 1 back together. This option requires that a spare locomotive is available. This option is estimated to take 3 hours. New departure time planned 14:00.
Action 1.3: The reason for the mid-train locomotive is to aid controlling Train 1 through gradients in the track terrain. If it can be determined that the mid-train locomotive is not needed for controlling the train on Subdivision A, then the locomotive can be cut out and considered as a dead-weight and Train 1 can proceed.
Action 1.4: A locomotive on another train will be required for Train 1, when that train arrives to the yard. Train 1 is de-prioritized, current crew taken off duty and a new crew will be ordered with the arrival of the replacement locomotive. This option requires inbound power availability and crew availability at the yard. This option could be 8 hours delay for Train 1 and is least favorable against the parameter.
Action 1.2 is selected and performed.

### Deviation 2 (Based on Selected Action 1.2)

Situation: Train 1 ready to depart Yard A at 14:00 and the planned arrival to Yard B is now 17:25. The Train crews 12 hours of service (HOS) expires at 19:00.
Symptom: Crew expires in less than 2 hours on arrival to Yard B and while traversing Subdivision A, Train 1 could encounter extra delays that could cause the train crew to expire on (HOS) before arriving at Yard B.
Parameter: Time remaining before train crew has expired (cannot operate the train past 12 hours on duty).
Root cause: Train 1 has delayed departure.
Action(s): Replace the train crew or reduce the potential for further delays.

### Proposed Actions (Alternatives):

Action 2.1: Recrew the train immediately in Yard A; parameter: Crew HOS
Action 2.2: Reduce potential delays en-route to Yard B; parameter: Crew HOS
Action 2.3: Wait and do nothing until last possible moment; parameter: Crew HOS
Action 2.4: Call out relief crew from Yard B in turn service to bring in the train; parameter: Crew HOS

### Details to Actions:

Action 2.1: Order a new crew right away to take over train in Yard A-if the first crew runs into troubles, the re-crew can complete the locomotive swap and once departed has no time issues to get to Yard B. This option requires that there is a crew available at Yard A. If there are no crews available, other options need to be explored. Train schedule/plan is updated with the new departure time and continues to authorize opposing trains with new planned meets.
Action 2.2: Change the priority of Train 1 for the remainder of the trip to Yard B, any work (pick-up) is passed up for another train to complete. Train schedule/plan ensures any opposing trains are in the clear to allow Train 1 to pass with no other delays. If the work online is critical and can't be passed up, other options would have to be explored.
Action 2.3: Train 1 departs with the original crew and original priority; a re-crew is planned but not triggered until the last possible moment.
Action 2.4: There is an available Relief Crew Lineup at Yard B. Train 1 is planned to tie down just outside of the yard and taxi in, and the Relief Crew will eventually bring Train 1 in.

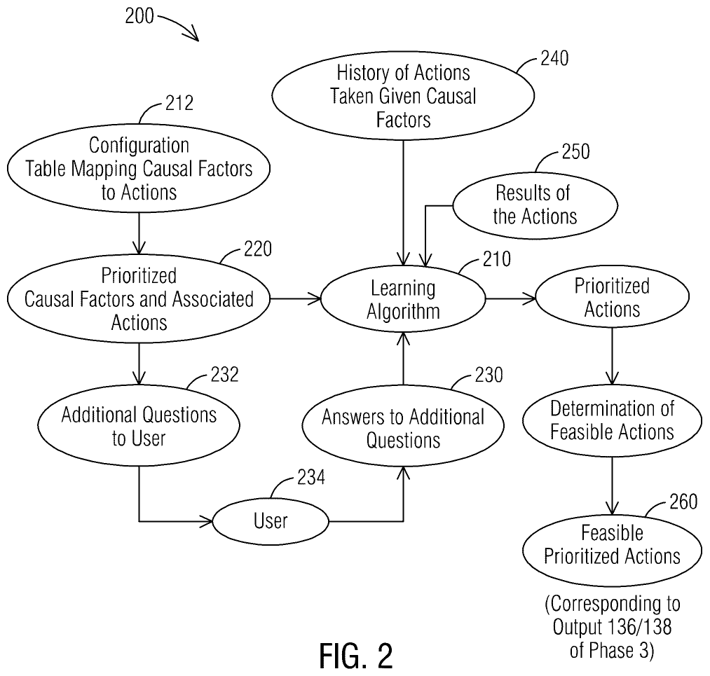

FIG. 2 illustrates a simplified flow chart and diagram 200 for managing traffic including a machine learning algorithm in accordance with an exemplary embodiment of the present disclosure.

In an exemplary embodiment of the present disclosure, prioritization of the automated actions and manual actions (phase 3 of method 100, see FIG. 1A) is performed utilizing a machine learning (ML) algorithm 210. In an example, the ML algorithm 210 is a supervised ML algorithm which is trained before implementing in method 100, and/or trained while being utilized and applied when performing the method 100.

Inputs into the ML algorithm 210 comprise prioritized causal factors and associated actions 220, answers to additional questions 230, based on additional questions 232 to a user/dispatcher 234, history 240 of previous actions taken given the set of causal factors, and results 250 of previous actions taken. Another input is the configuration table 212 mapping causal factors to actions. Outputs of the ML algorithm 210 include prioritized and feasible actions 260, which support and supplement phase 3 of method 100 in combination with outputs 136/138 of method 100. In another example, the ML algorithm 210 alone is configured to provide outputs of phase 3. In yet another example, phase 3 can be performed without ML algorithm 210, for example by providing and programming certain action(s) based on the respective causal factor(s).

Below is a table of inputs and usage of the inputs related to the determination of the feasible prioritized list of actions based on causal factors:

| Input | Usage |
|---|---|
| Configuration table | Input for a function performing for phase 3 (act |
| mapping causal | 130) determining prioritized action for associated |
| factors to action | causal factors |
| Prioritized causal | Input for determining if additional information is |
| factors and actions | required (questions, see 132); key input for ML |
| | algorithm 210 for determining best prioritized |
| | action |
| Answer to additional | Input to ML algorithm 210 for determining best |
| questions | prioritized action |
| History of previous | Input to ML algorithm 210 for determining best |
| actions taken for | prioritized action |
| the respective | |
| causal factors | |
| Results of previous | Input to ML algorithm 210 for determining best |
| actions take | prioritized action |
| Prioritized actions | Input to a function that determines, based on other |
| | knowledge of state within system, which of the |
| | prioritized proposed actions are feasible. |

FIG. 3 illustrates a block diagram of a traffic management system 300 in accordance with an exemplary embodiment of the present disclosure.

In an exemplary embodiment of the present disclosure, the traffic management system 300 is configured to execute or perform the method 100 for managing traffic as described with reference to FIG. 1A and FIG. 1B. Further, the traffic management system 300 may employ a machine learning (ML) algorithm 340 which can be the ML algorithm 210 as described with reference to FIG. 2.

The traffic management system 300 comprises a traffic management module 310 including a traffic management method or algorithm, that is configured, via processor 320 and memory 330 to receive traffic network data including sensor data from a plurality of sensors, wherein the traffic network data comprise vehicle data and infrastructure data within a traffic network, identify a deviation in a planned traffic network behavior based on the traffic network data and utilizing a defined parameter, wherein the deviation comprises a value outside a threshold of the defined parameter, determine a confidence level for the defined parameter and value, wherein the confidence level is calculated by evaluating whether one or more condition(s) associated with the defined parameter and value are true, identify a causal factor for the deviation, generate actions for the causal factors to correct the deviation, wherein an output includes a list of automated actions and manual actions, and trigger the automated actions.

The system 300, more specifically the train management module 310 is configured to receive input data 350, specifically traffic network input data via one or more interfaces. The traffic management module 310 is configured to execute traffic management, via a traffic management algorithm/method 100 as described herein.

The module 310 may be embodied as software or a combination of software and hardware. The module 310 may be a separate module or may be an existing module programmed to perform a method as described herein. For example, the module 310 may be incorporated, for example programmed, into a traffic management and control system, by means of software. In another example, the module 310 may be a firmware plugin into an existing system.

The traffic management system 300 further comprises a user interface 370 with display. For example, the list of automated actions and manual actions is displayed via the user interface 370. The user (e. g., dispatcher) can then provide input to the system 300, for example enter missing information or content, and select one or more automated and/or manual actions. Other features or information may be displayed via the user interface 370.

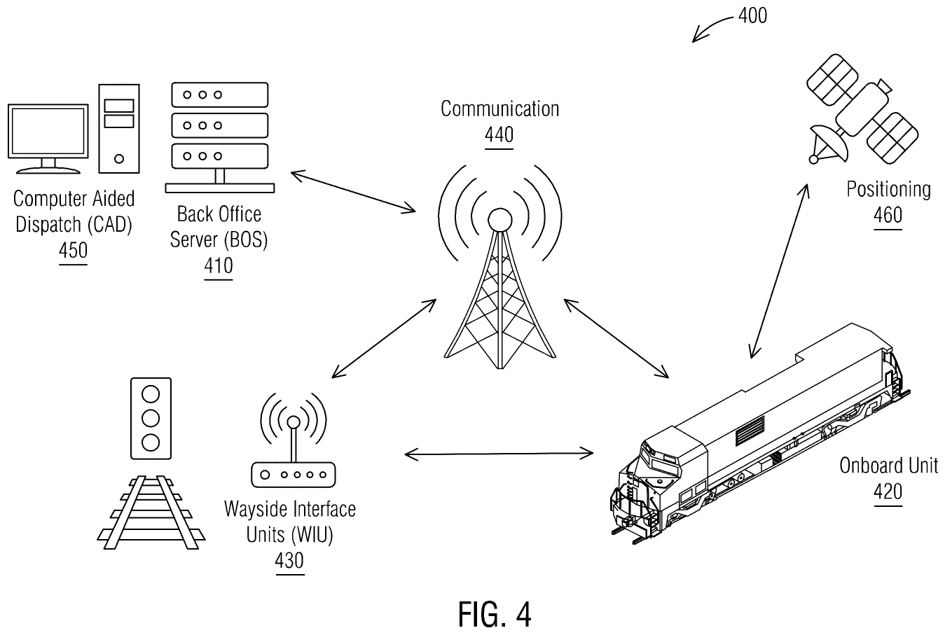

FIG. 4 illustrates a diagram of a train management and control system 400 in accordance with an exemplary embodiment of the present disclosure.

In an example, the train management and control system 400 is configured as positive train control (PTC) system. PTC is a system designed to prevent train-to-train collisions, derailments caused by excessive speeds, unauthorized train movements in work zones, and the movement of trains through switches left in the wrong position etc.

In an exemplary embodiment of the present disclosure, the traffic management module 310, as described with reference to FIG. 3, can be an individual system and operably coupled to computer aided dispatch (CAD) system 450, or the module 310 can be integrated or implemented by the CAD system 450. In this case, the processor 320 and memory 330 are part of the CAD system 450. The traffic management module 310 may be embodied as software or a combination of software and hardware. In an example, the traffic management module be installed, for example loaded or programmed, into the CAD system 450.

In general, PTC system 400 comprises back-office server system 410, herein also referred to as BOS system 410, an onboard unit 420 installed and operating in a locomotive of a train, herein also referred to as OBU 420, and a system of wayside interface units 430, herein also referred to as WIUs 430. Further, system 400 comprises a communication network 440 configured to interface with the BOS system 410, the OBU 420, and the WIUs 430. The PTC system 400 enables real-time information sharing between the BOS system 410, the OBUs 420 of trains, and WIUs 430, regarding train movement, speed restrictions, train position and speed, and the state of signal and switch devices etc.

The OBU 420 monitors and controls train movement, for example if train operator (engineer) fails to respond to (audible) warnings. The OBU 420 is in communication with a positioning system 460 to determine the position of the train. The positioning system 460 can be for example the Global Positioning System, known as GPS, and the OBU 420 can comprise a GPS receiver. The WIUs 430 are crucial components for collecting, processing, and transmitting data from wayside devices such as track circuits and signals to the BOS system 410 and/or OBU 420, via communication network 440. Such wayside information can include for example switch positions, signal states etc.

The BOS system 410 is a storehouse for speed restrictions, track geometry and wayside signaling configuration databases. The BOS system 410 is operably coupled to the CAD system 450. The CAD system 450 can be integrated in the BOS system 410. The CAD system 450 is configured to display and dispatch information/data, i. e. messages, to other components or sub-systems, such as the BOS system 410. In an example, the CAD system 450 comprises a human-machine-interface (HMI), e. g. computer and screen, and can be configured to display information on the screen, such as information/data collected by the WIUs 430. Further, the CAD system 450 can be configured such that information/data can be entered, for example manually by an operator, for further processing by the CAD system 450 and/or the BOS system 410.

1. A method for managing traffic, the method comprising, through operation of at least one processor in a traffic management system configured via computer executable instructions included in at least one memory:
receiving traffic network data including sensor data from a plurality of sensors, wherein the traffic network data comprise vehicle data and infrastructure data within a traffic network,
identifying a deviation in a planned traffic network behavior based on the traffic network data and utilizing a defined parameter, wherein the deviation comprises a value outside a threshold of the defined parameter,
determining a confidence level for the defined parameter and value, wherein the confidence level is calculated by evaluating whether one or more condition(s) associated with the defined parameter and value are true,
identifying a causal factor for the deviation,
generating actions for the causal factors to correct the deviation, wherein an output includes a list of automated actions and manual actions, and
triggering the automated actions.

2. The method of claim 1, further comprising:
displaying the list of automated actions and manual actions, and
receiving a user input including a selection of one or more automated and/or manual actions.

3. The method of claim 1, further comprising:
prioritizing, when more than one causal factor has been identified, the causal factors by applying a ranking function and utilizing the confidence level.

4. The method of claim 1, further comprising:
prioritizing the automated actions and manual actions in accordance with the causal factors.

5. The method of claim 4,
wherein the prioritizing of the automated actions and manual actions is performed utilizing a machine learning algorithm.

6. The method of claim 5,
wherein an input to the machine learning algorithm comprises prioritized causal factors and associated actions, answers to additional questions, history of previously triggered actions for the causal factors, and results of the previously triggered actions.

7. The method of claim 1, further comprising:
generating and displaying questions to a user in response to an error or lack in the prioritizing of the causal factors,
receiving a user input including responses to the questions, and
completing the prioritizing of the causal factors.

8. The method of claim 7,
wherein the user input further comprises information or data necessary to perform a selected action.

9. The method of claim 1, further comprising:
collecting and storing data of defined parameters in conjunction with performed actions, and
analyzing an impact of the defined parameters, thereby determining an effectiveness of the performed actions.

10. The method of claim 9,
wherein the prioritizing of suggested automated actions and manual actions is modified depending on the effectiveness of the actions.

11. A traffic management system comprising:
at least one memory and at least one processor, and
a traffic management module configured, via the at least one processor and the at least one memory, to
receive traffic network data including sensor data from a plurality of sensors, wherein the traffic network data comprise vehicle data and infrastructure data within a traffic network,
identify a deviation in a planned traffic network behavior based on the traffic network data and utilizing a defined parameter, wherein the deviation comprises a value outside a threshold of the defined parameter,
determine a confidence level for the defined parameter and value, wherein the confidence level is calculated by evaluating whether one or more condition(s) associated with the defined parameter and value are true,
identify a causal factor for the deviation,
generate actions for the causal factors to correct the deviation, wherein an output includes a list of automated actions and manual actions, and
trigger the automated actions.

12. The traffic management system of claim 11, further comprising:
a user interface with display, wherein the list of automated actions and manual actions is displayed via the user interface, and wherein the user interface allows providing input including a selection of one or more automated and/or manual actions.

13. The traffic management system of claim 11, wherein the processor is further configured to execute the instructions of the application to:
prioritize, when more than one causal factor has been identified, the causal factors by applying a ranking function and utilizing the confidence level.

14. The traffic management system of claim 13, wherein the processor is further configured to execute the instructions of the application to
prioritize the automated actions and manual actions in accordance with the causal factors.

15. The traffic management system of claim 14, further comprising:
a machine learning algorithm, wherein the automated actions and manual actions are prioritized utilizing the machine learning algorithm.

16. The method of claim 15,
wherein an input to the machine learning algorithm comprises prioritized causal factors and associated actions, answers to additional questions, history of previously triggered actions for the causal factors, and results of the previously triggered actions.

17. The traffic management system of claim 11,
implemented in a train management and dispatch system.

18. The traffic management system of claim 17,
wherein the train management and dispatch system is configured to receive commands to perform the automated actions and/or manual actions triggered via the train management module.

19. The traffic management system of claim 18,
wherein the train management and dispatch system is configured to transmit a dispatcher message to recipients including an on-board unit of a train.

20. A non-transitory computer readable medium storing executable instructions, which, when executed by a computer, perform a method for traffic management as claimed in claim 1.
